(19) United States
(12) Patent Application Publication
(10) Pub. No.: US 2020/0341968 A1
(43) Pub. Date: Oct. 29, 2020

(54) Differential Update of Local Cache from Central Database

(71) Applicant: Hewlett Packard Enterprise Development LP, Houston, TX (US)

(72) Inventors: Sudhakar Mohan, Santa Clara, CA (US); Michael Zayats, Santa Clara, CA (US); Aslam Khan, Santa Clara, CA (US)

(21) Appl. No.: 16/395,458

(22) Filed: Apr. 26, 2019

(51) Int. Cl. G06F 16/23; G06F 16/22; G06F 16/27; H04L 29/08

(52) U.S. Cl. CPC G06F 16/2379; H04L 67/2842; G06F 16/27; G06F 16/2282

(57) ABSTRACT

Examples include re-connecting to a central database with data stored in a table. The table may include a total number of rows. Examples also include sending a message to the central database including a request for a first number of rows out of the total number of rows and receiving from the central database a second number of rows out of the total number of rows. Examples additionally include determining a non-existing row out of the second number of rows in a local table stored in a local cache and inserting the non-existing row into the local table.

### BACKGROUND

Networking devices, such as switches, are used to connect other devices, such as servers, other switches, or routers, to create a network within a data center. The network devices allow for the sharing of resources, serving as a controller, thereby allowing devices on the network to share information and otherwise communicate. During operation, switches and other networking devices have various configurations and statuses that are stored in central databases in the form of tables. Clients may request information stored in the tables in order to monitor, debug, or configure the operability of the network devices.

### BRIEF DESCRIPTION OF THE DRAWINGS

The following detailed description references the drawings, wherein:

FIG. 1 is a schematic representation of a network system to provide data from a central database to clients, according to some examples.

FIG. 2 is a block diagram of a computing device that interacts with a central database, according to some examples.

FIG. 3 is a block diagram of a networking device that interacts with a remote client, according to some examples.

FIG. 4A is a schematic representation of interactions between a networking device and a remote client, according to some examples.

FIG. 4B represents tables as stored in the networking device of FIG. 4A and the remote client of FIG. 4A, according to some examples.

FIG. 5 is a block diagram of a flowchart of updating a local table based on data from a central database, according to some examples.

FIG. 6 is a block diagram of a flowchart of providing information from a central database, according to some examples.

### DETAILED DESCRIPTION

In the field of network computing, network connectivity between devices, compute nodes, blades, or frames of a scalable computing resource may be implemented using a networking device. Networking devices, such as switches, routers, hubs, bridges, etc. represent a primary communication path for sharing data between different types of computing resources generically referred to as “nodes” of a network. The shared data may represent inputs to computing processes (e.g., data or applications), outputs of computing resources (e.g., compute results), communications to coordinate distributed processes, communications between users, and other types of data.

In any “intelligent” networking device there may be a processor, local memory, configuration information, and “current state” information, among other types of information. Collectively, the different types of information on a networking device may be considered to represent the overall “device state” at a given point in time. For example, information on a networking device (including its “device state”) is expected to change over time, in part because while in-service and providing active communication paths for a network, the overall configuration and available devices on that network may change. In particular, routing information may change as devices become available or unavailable at different points in the overall network (e.g., a laptop device relocating). Information in routing tables and overall network connectivity may represent a portion of the device state of a networking device.

In general, a switch may be thought of as a device in a computer network that connects together other devices (“nodes” of the network). Multiple data cables may be plugged into a switch to enable communication between different networked devices. Switches manage the flow of data across a network, typically by transmitting a received network packet only to the one or more devices for which the packet is intended. Each networked device connected to a switch can be identified by its network address, allowing the switch to direct the flow of traffic, possibly in an effort to maximize the security and efficiency of the network. A switch is more intelligent than a hub (e.g., Ethernet hub), which simply retransmits packets out of every port of the hub except the port on which the packet was received. In most cases, a hub is unable to distinguish different recipients, and therefore may have an overall lower network efficiency, but simpler configuration information, than a switch/router. Generally, a router is a networking device that forwards data packets between computer networks. Routers perform the traffic directing functions on the Internet. A data packet is typically forwarded from one router to another router through the networks that constitute an internetwork until it reaches its destination node.

As explained further below, some networking devices are “hybrid” devices in that they perform more than one classification of service. That is, some switches may also be routers and some routers may also be switches and have hubs as part of their architecture. Accordingly, there are a variety of networking devices (commonly referred to as switches, hubs, routers, etc.) that may benefit from the concepts of this disclosure.

During operation, a networking device may run or otherwise employ various protocols and processes. For example, certain networking devices may employ various network layer protocols, such as layer 2 and layer 3 protocols. These protocols enable the sending of packets of data between switch ports or to different internet protocol addresses within a network. The networking device may use a central database to store configuration data, run time schedules, operational information, and/or other data regarding to all the processes and protocols running on the networking device. The data may be stored in tables in the central database, and in rows and columns in the tables. One non-limiting example of such a type of central database is an Open vSwitch Database (OVSDB).

The central database may be accessible (e.g., read and/or write) to any and/or all processes of networking device as a place for the processes to log activities of the processes and to inquire information about other processes on the networking device. Thus, one process running on the networking device may subscribe to changes that another process publishes to the central database. These processes may be characterized as local clients. Additionally, processes running on one networking device may also access the central database of another networking device. These processes may be characterized as remote clients.

With remote clients, the remote client may connect to the networking device, sync with the central database and retain a local copy of the relevant data (e.g., the relevant tables) in the central database. However, the connection (e.g., via Transmission control protocol (TCP)) between the networking device and the remote client may be lost due to network issues. In some situations, when disconnection occurs, the remote client wipes out the data that it previously received from the central database and re-populates its entire local copy of the table with data from the central database after re-connection. This re-population may include portions that are new since the re-connection and portions that are old (i.e. portions that were already in the local copy before it was deleted).

In some situations, the time between disconnection and reconnection is short resulting in no or little change to the table in the central database. The erasure and re-population of the local table may take up computing resources of both the networking device hosting the central database and the remote client that may be used elsewhere. Additionally, the erasing and re-population may take multiple CPU cycles by the remote client, thus lengthening the time in which the process on the remote client does not have access to information from the database. In situations where there are multiple disconnections over a short amount of time and/or multiple tables in the database that are relevant to the client, these issues may be exacerbated.

Examples herein address these technological problems by providing a method and system for a client to update changed portions of a local copy of a table while keeping unchanged portions the same. In some examples, the client reconnects to a central database after a disconnection and requests for the rows stored in a table in the central database. The table may comprise information that is relevant to the processes run by the client.

Because of the prior connection, the client already has a local copy of the table in a local cache. The client may request from the central database all of the rows that are present in its local copy. The networking device may determine which rows in the request are changed and which rows in the request are unchanged in the central database since the disconnection and send to the client the rows that are changed. In some examples, this determination may be made based on a version identifier of the row. The client, in return, may keep the rows that it did not receive data for and insert the rows that it receives data for. In some examples, one of the rows that it receives data may be a new row (i.e. a row that the client did not have in its local copy). In these examples, the client may insert the row in its entirety into the local copy. In some examples, one of the rows that it receives data may be an old row (i.e. a row that the client has in its local copy) but is modified. In these examples, the client may determine which columns in the row are changed and update those columns while keeping the other columns in the row the same. In some additional situations, the client may request for a row that has since been deleted from the central database. In these situations, the networking device may send data to the client indicating that the requested row has been deleted. Based on this information, the client may delete that specific row from its local copy of the table.

Accordingly, with the benefit of this disclosure, the networking device (with the central database) does not need to generate a snapshot of the entire table(s) each time a disconnect and reconnect occurs with a remote client. Instead, the networking device prepares a snapshot of what has changed and sends that smaller snapshot to the remote client. Similarly, the client does not need to erase its entire local copy and re-populate it. Instead, it may change only what has been updated since the last connection. This leads to efficient and faster syncing between the central database and the local copy on the remote client.

In some examples, a computing device is provided with a non-transitory machine-readable storage medium comprising instructions. The instructions, when executed, cause a processing resource to reconnect to a central database comprising data stored in a table. The table comprises a total number of rows, each of which are associated with a version identifier. The instructions also cause the processing resource to send a message to the central database comprising requested row information for a first number of rows out of the total number of rows and receive data from the central database. The data received from the central database comprises a second number of rows out of the total number of rows. The instructions also cause the processing resource to determine whether each row out of the second number of rows exists in a local table stored on a local cache and, based on a determination that there is an existing row, insert the existing row into the local table.

In some examples, a method comprises connecting to a central database comprising data stored in a table. The table may comprise a total number of rows each associated with a version identifier. The method also comprises sending a message to the central database requesting a first number of rows out of the total number of rows. The message may comprise a version identifier associated with each of the first number of rows. The method also comprises receiving data from the central database that comprises a second number of rows out of the total number of rows, and determining an existence of each row out of the second number of rows in a local table. Based on a determination that a row exists in the local table, the method comprises updating a modified column in the existing row. Based on a determination that a row does not exist in the local table, the method comprises inserting the non-existing row in the local table.

In some examples, a computing device is provided with a non-transitory machine-readable storage medium comprising instructions that, when executed, cause a processing resource to receive a message from a remote client. The message comprises a request for a number of rows from a table in a central database. The instructions also cause the processing resource to determine an unmodified row in the number of rows based on a unique identifier and a version identifier associated with the unmodified row and determine a modified row in the number of rows based on a unique identifier and a version identifier associated with the modified row. The instructions also cause the processing resource to send the modified row to the remote client.

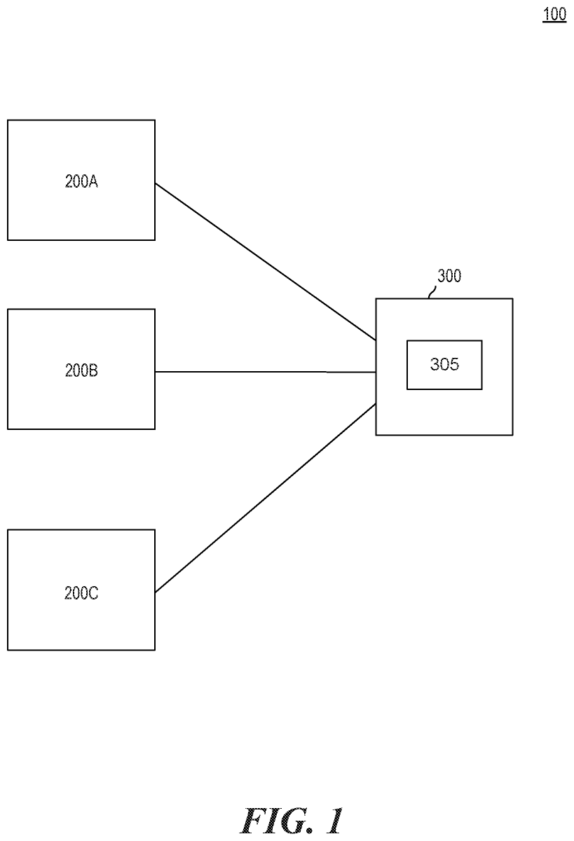

Referring now to the figures, FIG. 1 is a block diagram of a network system 100 to provide data to clients. Network system 100 may comprise networking device 300. As used herein, a networking device may be a device used in a network for the transmission of packets to the network (e.g. from an outside network), from the network (e.g. to an outside network), and/or within the network (from one device in the network to another device in the network). Non-limiting examples of a networking device include a router, switch, etc.

In one implementation, networking device 300 may be an aggregation switch which connects multiple switches together. Networking device 300 may employ various protocols and processes. The configuration and operation of networking device 300 may be recorded and stored in a central database 305.

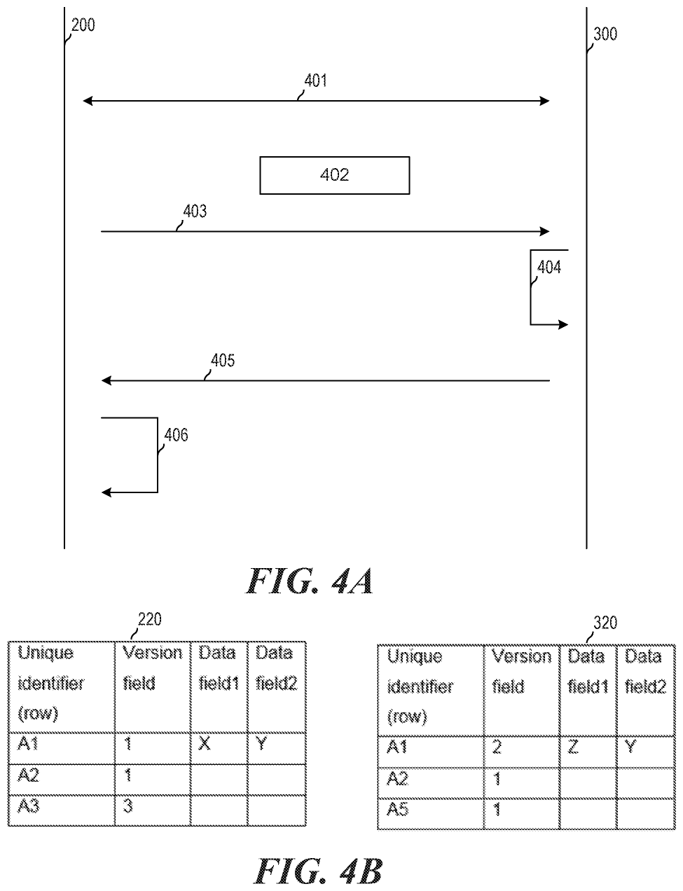

The data stored in central database 305 may be stored in a table format. Generally, the tables may include columns and rows forming individual blocks in which certain information is stored. A table may be associated with a unique identifier that allows a client and the central database to identify a specific table. The unique identifier may be an alphanumeric character. Additionally, each row in each table may have a unique identifier associated with that specific row that identifies the specific row. Each row may also be associated with a version identifier. The version identifier is changed (e.g., incremented, etc.) each time the row is updated. As discussed in relation to FIG. 4, the version identifier allows networking device to determine which rows are modified in light of a request from a client.

Central database 305 may be stored in a machine-readable storage medium. As used herein, “machine-readable storage medium” may include a storage drive (e.g., a hard drive), flash memory, Random Access Memory (RAM), any type of storage disc (e.g., a Compact Disc Read Only Memory (CD-ROM), any other type of compact disc, a DVD, etc.) and the like, or a combination thereof. In some examples, central database 305 may be stored in a main memory, such as a non-volatile random access memory. Storing central database 305 in a main memory allows for faster memory access due to reduced seek time, etc. In other examples, central database may be stored in an external memory that is connected to networking device 300.

Network system 100 also comprises computing devices 200A, 200B, 200C. As used herein, a “computing device” may include a server, a networking device, a chipset, a desktop computer, a workstation, a mobile phone, a tablet, an electronic reader, or any other processing device or equipment. Computing devices 200A, 200B, and 200C may subscribe to data stored in central database 305. Accordingly, computing devices 200A, 200B, 200C may be characterized as “clients”. In other words, these computing devices may run processes that subscribe to information stored in central database 305. Computing devices 200A, 200B, and 200C may be indirectly connected to networking device 300 such that they are remote from networking device 300. For example, computing devices 200A, 200B, and 200C may connect to networking device 300 via a TCP connection. Accordingly, they are remote clients (i.e. processes that run on computing devices other than networking device 300) and not local clients (i.e. processes that run networking device 300). Network system 100 may also include local clients, which are not shown in FIG. 1.

To access the tables in central database 305, computing device 200A, 200B, 200C (e.g. the processes running on them) may send a request in compliance with the database protocol to networking device 300. The request may include unique identifiers of the tables and unique identifiers of rows within each table, allowing the computing devices 200A, 200B, 200C to indicate a subset of data within the central database 305 that is relevant to its processes. This causes networking device 300 to respond and generate a snapshot of the requested tables and rows. Computing devices 200A, 200B, 200C receive the data, and each store the data in a table local to each computing device 200A, 200B, and 200C where the local tables are accessible to the processes on computing devices 200A, 200B, and 200C using the information.

Computing devices 200A, 200B, and 200C may connect to networking device 300 more than one time. For example, the first time that computing device 200A connects to networking device 300, it may generate an initial local copy of the relevant tables it receives from networking device 300 and store it in a local cache. The local cache may also be comprised of a machine-readable storage medium, as described above. Accordingly, computing device 200A has a local copy of the relevant tables of central database that is stored locally on computing device 200A.

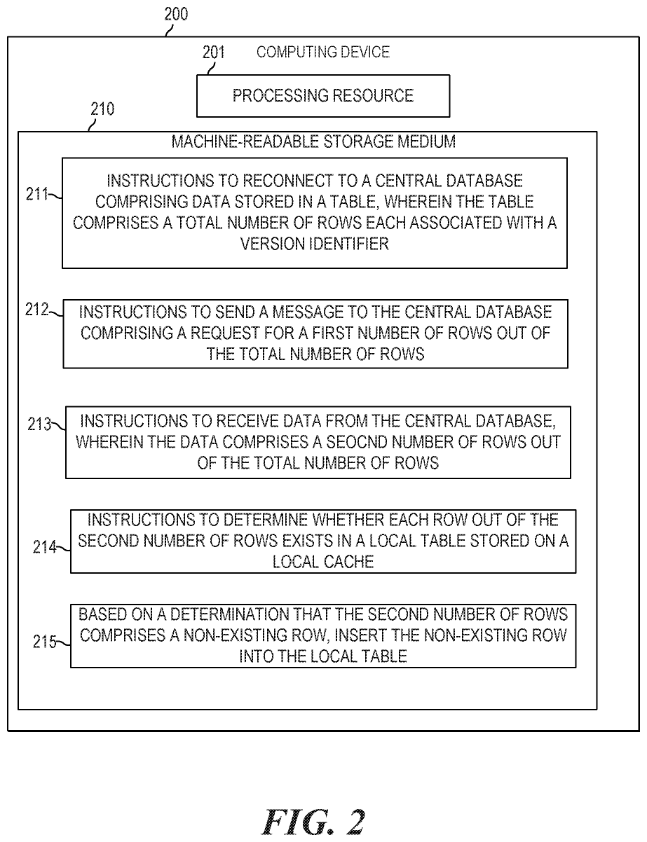

The connection between computing device 200A and networking device 300 may be interrupted due to network issues. Computing device 200A may re-connect to networking device 300 after the disconnection. During the disconnection time, central database 305 may be modified such that the local copy of the table(s) on computing device 200A may no longer include the most recent information found in central database 305. Computing device 200A may send another message to networking device 300, requesting the relevant tables and rows. The message may include, along with the unique identifiers for the tables and unique identifiers for the rows in the tables, a version identifier for each row. Based on the data received from networking device 300, the local table on computing device 200A may be updated accordingly, as described in relation to FIGS. 2-6.

FIG. 2 is a block diagram of a computing device 200 that interacts with a central database. In some examples, computing device 200 is a switch that is aggregated by an aggregation switch. Computing device 200 may be implemented in network system 100 as shown in FIG. 1 as either computing device 200A, 200B, or 200C. Computing device 200 includes a processing resource 201 and a machine-readable storage medium 210. Machine readable storage medium 210 may be in the form of non-transitory machine-readable storage medium, such as suitable electronic, magnetic, optical, or other physical storage apparatus to contain or store information such as instructions 211, 212, 213, 214, related data, and the like.

In the example of FIG. 2, instructions 211, 212, 213, and 216 are stored (encoded) on storage medium 210 and are executable by processing resource 201 to implement functionalities described herein in relation to FIG. 2. In some examples, storage medium 210 may include additional instructions. In other examples, the functionalities of any of the instructions of storage medium 210 may be implemented in the form of electronic circuitry, in the form of executable instructions encoded on machine-readable storage medium, or a combination thereof.

Processing resource 201 may, for example, be in the form of a central processing unit (CPU), a semiconductor-based microprocessor, a digital signal processor (DSP) such as a digital image processing unit, other hardware devices or processing elements suitable to retrieve and execute instructions stored in a storage medium, or suitable combinations thereof. The processing resource can, for example, include single or multiple cores on a chip, multiple cores across multiple chips, multiple cores across multiple devices, or suitable combinations thereof. The processing resource can be functional to fetch, decode, and execute instructions 211, 212, 213, and 214 as described herein.

Instructions 211 may be executable by processing resource 201 to re-connect to a central database. The central database may be similar to central database 305 as described in relation to FIG. 1. The central database comprises data that is stored in at least one table (e.g. one table, two tables, three tables, etc.) with each table having at least one row (e.g. one row, two rows, three rows, etc.). The at least one table may be identified with a unique identifier.

The at least one table may have a total number of rows with each row being associated with a unique identifier and a version identifier. The version identifier may be stored in a version field such that it is tied to a specific row in a specific column. The version identifier may get updated when the row is modified. For example, a table in central database may have a unique identifier of 1 in central database. Table 1 may have two rows with unique identifiers A1 and A2, respectively. Row A1 may have a version identifier of 1, indicating that it is the “first” version of row A1 in Table 1 and row A2 may have a version identifier of 2, indicating that it is the “second” version of row A2. When row A1 is modified in the central database, the version identifier is changed to 2, indicating that the central database has version 2 of row A1 in Table 1.

When computing device 200 first connects to the networking device hosting central database, it sends a message requesting for Table 1. Networking device hosting central database sends Table 1 with rows A1 and A2. At the time of connection, row A1 has a version identifier of 1 and row A2 has a version identifier of 2. Computing device 200 retains a local copy of Table 1 in its local cache (not shown in FIG. 2). Table 1 in the local cache of computing device 200, similar to Table 1 in central database, also has rows A1 and A2, with A1 having a version identifier of 1 and row A2 having a version identifier of 2. This first copy of Table 1 into the local cache of computing device 200 may be characterized as an initial copy of Table 1.

Upon a network interruption, the connection between computing device 200 and the networking device hosting central database is lost. When the network is established again, computing device 200 reconnects to networking device with the central database. Thus, as used herein, a re-connection includes a second, third, fourth, etc. connection between computing device 200 and the device with the central database. Thus, when computing device 200 reconnects to the central database, computing device 200 already has a local copy of the table. The reconnection may be completed via the original form of connection, e.g., via TCP.

The local copy may be outdated, however. Instructions 212-214 allow computing device 200 to update portions that are changed.

Instructions 212 may be executable by processing resource 201 to send a message to the central database. The message may include a request for a first number of rows out of the total number of rows in the table. As used herein, a total number of rows in the table characterizes the complete number of rows that a table in the central database has at the time the central database receives the request. The first number of rows in the request characterizes the number of rows that computing device 200 has of the table in its local cache. The total number that a table in the central database has may be different from the first number of rows. That is because the table may have been updated during the disconnection between the central database and computing device 200. For example, Table 1, as discussed above, may have started with two rows, A1 and A2. But, during the disconnection, Table 1 may have been updated with another row, row A3. Thus, at the time that message of instructions 212 is received by the central database, the total number of rows of Table 1 on central database is 3. However, at the time the local copy of Table 1 was created in computing device 200, Table 1 only had two rows. Thus, the local copy of Table 1 only has two rows: A1 and A2. Accordingly, computing device 200 does not know about row A3 and will not request for row A3 in the message of instructions 212. Accordingly, in this example, the first number of row is 2 while the total number of rows is 3.

In other examples, the total number of rows and the first number of rows may be different because a row is deleted from Table 1 in central database during the disconnection. In these examples, the total number of rows is less than the first number of rows.

In some examples, however, the total number of rows and the first number of rows may be the same. This may occur when Table 1 in the central database has not had any rows added or deleted during the disconnection.

The request may include the unique identifier for the table and the unique identifier(s) for the rows requested. This allows central database to determine which tables and rows are relevant to computing device 200.

The request may also include the version identifiers associated with each row. The version identifiers sent in the request comprise the ones that are stored on the local cache. These may or may not be the same version identifiers that are associated with the rows in the central database. This is because the rows may be modified during disconnection. Using the version identifiers in the request, the central database may determine which rows have been modified and which ones are not modified relevant to the copy of Table 1 stored in computing device 200's local cache.

For example, the request may include a request for rows A1, version 1, row A2, version 2. However, Table 1 in central database has rows A1, version 2, and row A2, version 2. Thus, the central database determines that row A1 has been modified. The central database sends this data to computing device 200.

Instructions 213 may be executable by processing resource 201 to receive the data from the central database. The data comprises a second number of rows out of the total number of rows. As used herein, a second number of rows characterizes the rows that central database determines are: 1) modified or 2) new rows. The second number may be the same or different from the first number of rows.

For example, in the situation where all the rows requested by computing device 200 are modified and no new rows are added or deleted, the first number and the second number are the same. This is because the central database sends over data for all the rows requested for.

As another example, in the situation where some of the rows requested by computing device 200 are modified or rows or added or deleted, the first number and the second number are different. This is because the central database sends over only the modified rows and does not send over the un-modified rows. Additionally, when a row that is requested for is no longer in the table in the central database (i.e. the row has been deleted), the central database does not send over the deleted row. Additionally, when a new row exists in the table in the central database (i.e. a new row) that is not requested for by computing device 200, central database sends over data for the new row. The data for the second number of rows may include a unique identifier for each row and a version identifier for each row.

Instructions 214 may be executable by processing resource 201 to determine whether each row out of the second number of rows exists in the local table stored on the local cache of computing device 200.

As discussed above, the central database may send new rows (i.e. ones that were not in the request by computing device 200 and thus are “new” or “non-existing” to computing device 200) and modified rows (i.e. ones that were in the request by computing device 200 and thus are “existing” to computing device 200). Instructions 214 may include instructions that, when executed, cause processing resource 201 to determine which rows in the second number of rows are new and which rows in the second number of rows already exists in the local table. In some examples, the determination is made based on a comparison of the unique identifier of the rows as kept in the local copy of the table and the unique identifier of the rows that are sent by the central database.

Based on a determination that a unique identifier in the data sent by the central database does not match a unique identifier of a row in the local copy of the table, computing device 200 determines that the specific row associated to that unique identifier does not exist in the local copy (and is “new” or “non-existing”).

Instructions 215 may be executable by processing resource 201 to insert the non-existing row into the local table based on a determination that the second number of rows comprises a non-existing row. In some examples, inserting a row into the local table includes inserting the entire row as it was sent by the central database.

However, a row in the second number of rows may be old or “existing” in the local table. Thus, instructions on computing device 200 may also include instructions to determine whether each row out of the second number of rows exists in the local table. This determination can be made by comparing the unique identifiers of the rows in the request and in the data sent by central database. A match between a unique identifier in the data sent by central database and a unique identifier in the local table indicates that the specific row exists in the local table. Thus, based on a determination that a unique identifier of a row in the data sent by central database matches a unique identifier of a row in the local copy of the table, computing device 200 determines that the specific row associated to that unique identifier already exists in the local table.

Based on a determination that a row in the second number of rows exists in the local copy of the table, computing device 200 may determine specific columns in that row that are modified and specific columns that are not modified. For example, instructions on computing device 200 may include instructions that, when executed, cause processing resource 201 to take a differential of the specific row as sent by the central database and the specific row as it exists in the local copy. The differential allows computing device 200 to determine which columns in the row are modified and which columns are unmodified. Computing device 200 may accordingly update only the modified columns and leave the unmodified columns unchanged in the local copy of the table.

As discussed above, in some examples, computing device 200 may request a row that no longer exists on central database (i.e. a deleted row). In these situations, the data sent by central database may include identifying information describing the deleted row. For example, the information may include the unique identifier for the table and the unique identifier for the deleted row. Accordingly, instructions on computing device may include instructions, that when executed, cause processing resource 201 to delete the deleted rows from the local copy of the table.

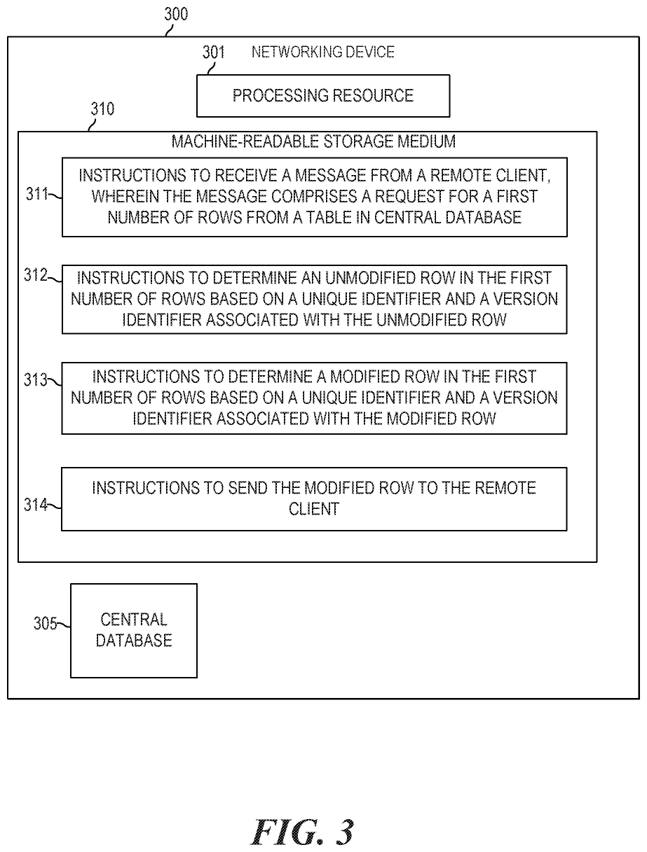

FIG. 3 illustrates a block diagram of a networking device 300 that interacts with a remote client, such as computing device 200 as shown in FIG. 2. Networking device 300 may be used as networking device 300 in network system 100 of FIG. 1. As discussed above, in some examples, networking device 300 may be a switch.

Networking device 300 comprises processing resource 301, machine-readable storage medium 310, and instructions 311, 312, 313, and 314 stored on machine-readable storage medium 310. Networking device also comprises central database 305.

Instructions 311 may be executable by processing resource 301 to receive a message from a remote client (e.g., computing device 200 of FIG. 2). The message may comprise a request for a first number of rows from a table in central database 305. As discussed above in relation to FIG. 2, the message may include a unique identifier for the table, unique identifiers for each row in the first number of rows, and a version identifier for each row in the first number of rows.

Instructions 312 may be executable by processing resource 301 to determine an unmodified row in the first number of rows. The row is characterized as unmodified because the row has not changed during disconnection between the remote client and networking device 300. In other words, the copy that the remote client has of the row in its local cache (the local table) is the same as the row that exists in central database 305 at the time networking device 300 receives the message.

In some examples, an unmodified row may be determined by comparing each unique identifier and version identifier for each row in the first number of rows with each unique identifier and version identifier for the rows in the table in central database 305. For example, a message may comprise a request for Row A1, version 1 and Row A2, version 2. Accordingly, the request is for Rows A1 and Row A2 and in the message, the remote client is telling computing device 300 that it currently has version 1 of Row A1 and version 2 of Row A2.

Instructions 312 may cause processing resource 301 to compare A1, V1 with each row in Table 1 on central database 305. Based on a determination that a row in Table 1 has the same unique identifier for the row (A1) and same version identifier (V1) in the request, networking device 300 determines that that specific row is unmodified.

Instructions 313 may be executable by processing resource 301 to determine a modified row in the first number of rows.

The row is characterized as modified because the row has changed during disconnection between the remote client and networking device 300. In other words, the copy that the remote client has of the row in its local cache (the local table) is not the same as the row that exists in central database 305 at the time networking device 300 receives the message.

For example, instructions 313 may also cause processing resource 301 to compare A2, V2 with each row in Table 1 on central database 305. Based on a determination that no row in Table 1 has the same unique identifier for the row (A2) and same version identifier (V2) in the request, networking device 300 determines that that specific row is modified.

Instructions 314 may be executable by processing resource 301 to send the modified row to the remote client. Additionally, instructions 314 may be executable by processing resource 301 to not send the unmodified row to the remote client. Accordingly, the remote client only receives rows in its request that are modified and does not receive rows that are unmodified (unchanged). This reduces the amount of data that networking device 300 sends to remote client.

In some examples, machine-readable storage medium 310 may also include instructions to determine a new row in the table in central database 305. The new row is a row that exists in the table in central database 305 but does not exist in the local copy of the table in the remote client at the time the message is received by networking device 300. In some examples, the new row is determined by comparing the unique identifiers for all of the rows in the first number of rows to the unique identifiers for all of the rows in the table on central database 305. Based on a determination that the table central database 305 has a row with a unique identifier that is not present in the first number of rows sent by the message, networking device 300 determines that that specific row is new (i.e. does not exist in the local copy of the table). Machine-readable storage medium 310 may also include instructions to send the new row to the remote client.

In some examples, machine-readable storage medium 310 may also include instructions to determine a deleted row in the table in central database 305. The deleted row is a row that exists on the local copy of the table in the remote client but does not exist in the table in central database 305 at the time the message is received by networking device 300. In some examples, the deleted row is determined by comparing the unique identifiers for all of the rows in the first number of rows to the unique identifiers for all of the rows in the table on central database 305. Based on a determination that the message includes a request for a row with a unique identifier that is not present in the table central database 305, networking device 300 determines that that specific row is deleted (i.e. does not exist in the table in central database 305). Machine-readable storage medium 310 may also include instructions to identifying information to the remote client to indicate that the row is deleted. This identifying information may include the unique identifier for the table in which the row was located and the unique identifier for the deleted row.

FIG. 4 illustrates a schematic representation of interactions between a networking device 300 (with a central database) and a remote client 200. FIG. 4B represents a table 320 in the central database on networking device 300 and a local copy 220 of the table on computing device 200. The tables 320 and 220 have the same unique identifier T2. While tables 320 and 220 are shown having a specific number of data fields (or columns), the tables can include additional or less columns than shown. Each row in the tables are associated with a unique identifier and a version identifier (version field).

Referring to FIG. 4A, line 401 represents an initial connection between networking device 300 and remote client 200. This may occur via connections known in the art, such as TCP, etc. During the initial connection, the remote client 200 may request for access to specific tables stored on the central database on networking device 300. One of these specific tables may be the table having the unique identifier of T2. Networking device 300 may respond to the request and send the table T2 to remote client 200. At the time of 401, table T2 in central database looks similar to table 220 as shown in FIG. 4B.

Remote client 200 creates a local copy of the table T2 in its local cache, creating table 220 as shown in FIG. 4B.

At 402, the connection between remote client 200 and networking device 300 is lost, resulting in a disconnection. During this time, the table T2 on networking device 300 is changed from looking like table 220 in FIG. 4B to table 320 in FIG. 4B. At 403, remote client 200 re-connects to networking device 300. Remote client 200 sends a message requesting for a first number of rows in table T2. The message includes the unique identifiers for each row in table T2 as shown in table 220 of FIG. 4B (rows A1, A2, and A3). As discussed above, this may be characterized as a first number of rows. Additionally, the message includes the version fields for each row (V1, V2, V3, respectively).

At 404, networking device 300 receives the message and determines which rows out of the first number of rows to send. At 404, central database has 3 rows, which may be characterized as the total number of rows. It determines that row A1 is modified (based on the different version field) and that row A2 is unmodified (based on the same version field). Accordingly, it sends row A1 and not row A2. In sending row A1, it sends the entire row because networking device 300 does not determine which specific columns in the row is modified. Networking device 300 also determines that row A3 no longer exists in table 320 and sends data to remote client 200 that identifies row A3 as being deleted. Additionally, networking device 300 also determines that row A5 is new as the unique identifier A5 is not captured in the first number of rows sent in the request. Accordingly, networking device 300 sends row A5 to remote client 200. Thus, at 405, networking device 300 sends over data including, row A1 and row A5 and data that allows remote device to identify row A3 as being a deleted row. Row A2 is not sent.

At 406, remote client 200 receives the second number of rows from networking device 300. Because it does not receive any data for row A2 (which was in its request), remote client does not modify row A2 as shown in table 220 of FIG. 4B. Remote client 200 receives data for row A1 and new row A5. Because unique identifier A5 does not exist in table 220, remote client 220 inserts the entire row A5 into table 220. Because unique identifier A1 exists in table 220, remote client 220 takes a differential between A1 as it is shown in table 220 and the data for A1 that it received from networking device 300. The differential shows that the version field is modified (from 1 to 2) and that data field1 is modified (from X to Z) and that data field2 is unmodified. Accordingly, remote client changes only the version field and data field1 and leaves data field2 unchanged. Additionally, remote client 200 may also delete row A3 based on the data it received from networking device 300 indicating that row A3 is a deleted row.

Accordingly, after 406, table 220 as shown in FIG. 4B is modified to look like table 320. Thus, remote client 200 now has the same table T2 that networking device 300 has on the central database.

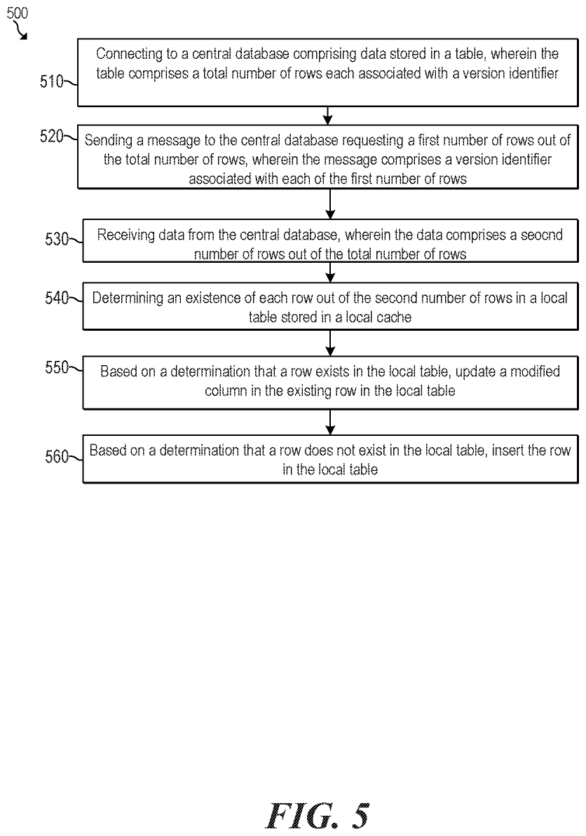

FIG. 5 illustrates a flowchart for method 500 to update a local table based on information from a central database. Although execution of method 500 is described below with reference to computing device 200A, other suitable devices for execution of method 500 may be used (e.g., computing device 200 of FIG. 2, remote client 200 of FIG. 4).

At 510, computing device 200A connects to central database 305 on networking device 300. The central database includes data stored in a table. The table has a total number of rows that each associated with a version identifier.

At 520, computing device 200A sends a message to central database 305 requesting a first number of rows out of the total number of rows. The message may comprise a version identifier associated with each of the first number of rows.

At 530, computing device 200A receives data from central database 305. The data comprises a second number of rows out of the total number of rows.

At 540, computing device 200A determines an existence of each row out of the second number of rows in a local table stored in its local cache.

At 550, based on a determination that a row exists in the local table, computing device 200A updates a modified column in the existing row in the local table.

At 560, based on a determination that a row does not exist in the local table, computing device 200A inserts the row into the local table.

Although the flowchart of FIG. 5 shows a specific order of performance of certain functionalities, method 500 is not limited to that order. For example, some of the functionalities shown in succession may be performed in a different order, may be executed concurrently or with partial concurrence, or a combination thereof. In some examples, functionalities described herein in relation to FIG. 5 may be provided in combination with functionalities described herein in relation to any of FIGS. 1-4 and 6.

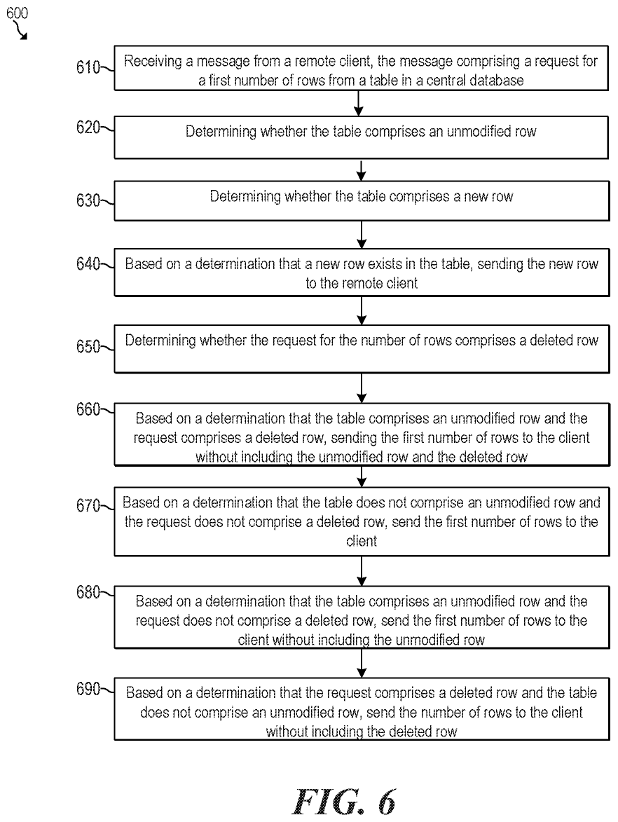

FIG. 6 illustrates a flowchart for method 600 of providing information from a central database. Although execution of method 600 is described below with reference to networking device 300, other suitable devices for execution of method 600 may be used (e.g., networking device 300 of FIG. 3, networking device 300 of FIG. 4).

At 610, networking device 300 receives a message from a remote client (e.g. computing device 200B) requesting for a first number of rows from a table in central database 305.

At 620, networking device 300 determines whether the table in central database 305 comprises an unmodified row. This is based on a comparison between the unique identifiers for the first number of rows and the unique identifiers of the rows present in the table in central database 305. This is also based on a comparison of the version identifier that is associated with each row in central database 305 and the version identifier that is associated with each row in the first number of rows.

At 630, networking device 300 determines whether the table in central database 305 comprises a new row. This is based on a comparison between the unique identifiers for the first number of rows and the unique identifiers of the rows present in the table in central database 305.

At 640, based on a determination that a new row exists in the table in central database 305, networking device 300 sends the new row to the remote client.

At 650, networking device 300 determines whether the request for the first number of rows comprises a deleted row. This is based on a comparison between the unique identifiers for the first number of rows and the unique identifiers of the rows present in the table in central database 305.

At 660, based on a determination that the table comprises an unmodified row and the request comprises a deleted row, networking device 300 sends the first number of rows to the client but excludes from the first number of rows the unmodified row and the deleted row.

At 670, based on a determination that the table does not comprise an unmodified row and the request does not comprise a deleted row, networking device 300 sends the first number of rows to the client.

At 680, based on a determination that the table comprises an unmodified row and the request does not comprise a deleted row, networking device 300 sends the first number of rows to the client but excludes from the first number of rows the unmodified row.

At 690, based on a determination that the request comprises a deleted row and the table does not comprise an unmodified row, networking device 300 sends the first number of rows to the client but excludes from the first number the deleted row.

Although the flowchart of FIG. 6 shows a specific order of performance of certain functionalities, method 600 is not limited to that order. For example, some of the functionalities shown in succession may be performed in a different order, may be executed concurrently or with partial concurrence, or a combination thereof. In some examples, functionalities described herein in relation to FIG. 6 may be provided in combination with functionalities described herein in relation to any of FIGS. 1-5.

All of the features disclosed in this specification (including any accompanying claims, abstract and drawings), and/or all of the elements of any method or process so disclosed, may be combined in any combination, except combinations where at least some of such features and/or elements are mutually exclusive.

What is claimed is:

1. A non-transitory machine-readable storage medium comprising instructions, that when executed, cause a processing resource to:
re-connect to a central database comprising data stored in a table, wherein the table comprises a total number of rows each associated with a version identifier;
send a message to the central database comprising a request for a first number of rows out of the total number of rows;
receive data from the central database, wherein the data comprises a second number of rows out of the total number of rows;
determine whether each row of the second number of rows exists in a local table stored in a local cache; and
based on a determination that the second number of rows comprises a non-existing row, insert the non-existing row into the local table.

2. The non-transitory machine-readable storage medium of claim 1, wherein the requested row information comprises a version identifier for each of the first number of rows.

3. The non-transitory machine-readable storage medium of claim 1, wherein the requested row information comprises a unique identifier for each of the first number of rows.

4. The non-transitory machine-readable storage medium of claim 1, wherein the local table comprises the first number of rows; and
wherein the instructions, when executed, cause the processing resource to keep an unchanged row, wherein the unchanged row is in the first number of rows but not in the second number of rows.

5. The non-transitory machine-readable storage medium of claim 1, wherein the instructions, when executed, cause the processing resource to:
based on a determination that the second number of rows comprises a an existing row, determine a modified column in the existing row; and
update the modified column in the local table.

6. The non-transitory machine-readable storage medium of claim 5, wherein the instructions, when executed, cause the processing resource to:
based on the determination that the second number of rows comprises a the existing row, determine an unmodified column in the existing row; and
leave the unmodified column unchanged in the local table.

7. The non-transitory machine-readable storage medium of claim 1, wherein the data comprises identifying information for a deleted row out of the first number of rows; and
wherein the instructions, when executed, cause the processing resource to delete the deleted row from the local table.

8. The non-transitory machine-readable storage medium of claim 1, wherein the instructions, when executed, cause the processing resource to generate an initial copy of the local table.

9. A method comprising:
connecting to a central database comprising data stored in a table, wherein the table comprises a total number of rows each associated with a version identifier;
sending a message to the central database requesting a first number of rows out of the total number of rows, wherein the message comprises a version identifier associated with each of the first number of rows;
receiving data from the central database, wherein the data comprises a second number rows out of the total number of rows;
determining an existence of each row out of the second number rows in a local table;
based on a determination that a row out of the second number of rows exists in the local table, update a modified column in the existing row; and
based on a determination that a row out of the second number of rows does not exist in the local table, insert the non-existing row in the local table.

10. The method of claim 9, wherein the total number of rows are each associated with a unique identifier; and
wherein the local table comprises the first number of rows each associated with a unique identifier.

11. The method of claim 10, wherein the determining of the existence of each row out of the second number of rows is based on a comparison of the unique identifiers associated with the first number of rows and the unique identifiers associated with the second number of rows.

12. The method of claim 9, wherein the data from the central database comprises information for a deleted row; and
wherein the method comprises deleting the deleted row from the local table.

13. The method of claim 9, wherein the local table comprises the first number of rows;
wherein the method comprises keeping an unchanged row; and
wherein the unchanged row is in the first number of rows but not in the second number of rows.

14. The method of claim 9, comprising determining the modified column, wherein the determination of the modified column comprises taking a differential between the data sent by the central database and the existing row.

15. The method of claim 9, wherein each row in the second number of rows comprises a number of columns.

16. A non-transitory machine-readable storage medium comprising instructions, that when executed, cause a processing resource to:
receive a message from a remote client, wherein the message comprises a request for a first number of rows from a table in a central database;
determine an unmodified row in the number of rows based on a unique identifier and a version identifier associated with the unmodified row;
determine a modified row in the number of rows based on a unique identifier and a version identifier associated with the modified row; and
send the modified row to the remote client.

17. The non-transitory machine-readable storage medium of claim 16, wherein the instructions, when executed, cause the processing resource to:
not send the unmodified row.

18. The non-transitory machine-readable storage medium of claim 16, wherein the instructions, when executed, cause the processing resource to:
determine a new row that is present in the table but not in the request; and
send the new row to the remote client.

19. The non-transitory machine-readable storage medium of claim 18, wherein the determination of the new row is based on a unique identifier associated with the new row.

20. The non-transitory machine-readable storage medium of claim 16, wherein the instructions, when executed, cause the processing resource to:
determine a deleted row out of the first number of rows; and
send data comprising information of the deleted row to the remote client.
